(19) United States
(12) Patent Application Publication
(10) Pub. No.: US 2009/0120519 A1
(43) Pub. Date: May 14, 2009

(54) WATER OUTLET DEVICE

(76) Inventor: Tom Chen, Changhua City (TW)

Correspondence Address: BARNES & THORNBURG LLP, 750-17TH STREET NW, SUITE 900, WASHINGTON, DC, 20006-4675, US

(21) Appl. No.: 11/939,302

(22) Filed: Nov. 13, 2007

(51) Int. Cl. F16K 11/00; F16K 31/60

(52) U.S. Cl. 137/625.46

(57) ABSTRACT

A water outlet device includes a hollow main body having a middle body part surrounding an axis, a water inlet pipe part fluidly communicated with the middle body part, and first and second water outlet pipe parts fluidly communicated with the middle body part via first and second water outlet holes, respectively. The water outlet device further includes a rotatable plug disposed in the middle body part and formed with a water conduit section, and a spring-loaded valve unit mounted to the rotatable plug and angularly spaced apart from the water conduit section relative to the axis. The water outlet device is operable to permit fluid communication between the water inlet pipe part and one of the first and second water outlet pipe parts by blocking one of the first and second water outlet holes that corresponds to the other one of the first and second water outlet pipe parts.

### BACKGROUND OF THE INVENTION

1. Field of the Invention

The invention relates to a tapware, more particularly to a water outlet device that has a good leakproofing effect and that can provide multiple water output modes.

2. Description of the Related Art

As shown in FIGS. 1 to 3, a conventional water outlet device comprises a main body 1 having a receiving space 101, a water inlet pipe part 102 that is connected to the main body 1 and that fluidly communicates with the receiving space 101, a first water outlet pipe part 103 that is connected to the main body 1, that is disposed opposite to the water inlet pipe part 102, and that fluidly communicates with the receiving space 101, and a second water outlet pipe part 104 that is connected to the main body 1, that fluidly communicates with the receiving space 101, and that is angularly spaced apart from both of the water inlet pipe part 102 and the first water outlet pipe part 103 by 90 degrees. The conventional water outlet device further comprises a switch plug 2 disposed fittingly and rotatably in the receiving space 101, a handle 3 mounted on the switch plug 2, a snap ring 4 disposed for retaining the switch plug 2 within the receiving space 101, a screw 5 for retaining the handle 3 on the top of the switch plug 2, and first and second shower heads 6, 7 connected respectively to the first and second water outlet pipe parts 103, 104. The switch plug 102 is formed with a first water passage 201 extending diametrically therethrough, and a second water passage 202 extending perpendicular to the first water passage 201 from the periphery of the switch plug 2 to the middle of the first water passage 201.

When the switch plug 102 is rotated to an angular position (see FIG. 2) where the first water passage 201 fluidly communicates with the water inlet pipe part 102 and the first water outlet pipe part 103, the second water outlet pipe part 104 is blocked by the outer surface of the switch plug 2, such that water can only flow outwardly of the main body 1 via the first shower head 6. When the switch plug 102 is rotated by 90 degrees to another angular position (see FIG. 3) where the second water passage 202 fluidly communicates with the water inlet pipe part 102, and where the first water passage 201 fluidly communicates with the second water outlet pipe part 104, the first water outlet pipe part 103 is blocked by the outer surface of the switch plug 2, such that water can only flow outwardly of the main body 1 via the second shower head 7.

However, since the switch plug 2 and the main body 1 are generally metallic, wear between the switch plug 2 and the main body 1 during the rotation of the switch plug 2 damages the fitting contact therebetween, thereby resulting in water leakage through the blocked one of the water outlet pipe parts 103, 104. Moreover, water can only flow out from the conventional water outlet device via one of the first and second shower heads 6, 7 at one time instead of flowing out via both shower heads 6, 7 at the same time, thereby resulting in inconvenience during use.

### SUMMARY OF THE INVENTION

Therefore, one object of the present invention is to avoid a water outlet device that can reduce wear between components to achieve a good leakproofing effect and a longer service life.

Another object of the present invention is to provide a water outlet device that can provide more water output modes compared to the prior art.

Accordingly, a water outlet device of the present invention comprises a hollow main body that includes a middle body part, a water inlet pipe part, and first and second water outlet pipe parts, and a switch mechanism that includes a rotatable plug and a spring-loaded valve unit. The middle body part has an inner annular surface surrounding an axis, defining a receiving space, and formed with a water inlet hole and first and second water outlet holes. The water inlet pipe part is connected to the middle body part and is fluidly communicated with the receiving space via the water inlet hole. The first and second water outlet pipe parts are connected to the middle body part and are fluidly communicated with the receiving space via the first and second water outlet holes, respectively. The rotatable plug has a water control portion disposed in the receiving space and rotatable about the axis. The water control portion has an outer surface with a valve mounting section and a water conduit section angularly spaced apart from the valve mounting section with respect to the axis. The spring-loaded valve unit is mounted to the valve control portion and is disposed to abut against the inner annular surface for blocking the first and second water outlet holes selectively. The water conduit section is configured to permit fluid communication between the water inlet pipe part and the first water outlet pipe part when the water control portion is at a first angular position relative to the axis that enables the spring-loaded valve unit to block the second water outlet hole, and to permit fluid communication between the water inlet pipe part and the second water outlet pipe part when the water control portion is at a second angular position relative to the axis that enables the spring-loaded valve unit to block the first water outlet hole.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional water outlet device;

FIG. 2 is an assembled sectional top view of the conventional water outlet device, illustrating a switch plug at one angular position;

FIG. 3 is a view similar to FIG. 2, but illustrating the switch plug at another angular position;

FIG. 4 is an exploded perspective view of a first preferred embodiment of a water outlet device according to the invention;

FIG. 5 is an assembled sectional side view of the first preferred embodiment;

FIG. 6 is an assembled sectional top view of the first preferred embodiment, illustrating a rotatable plug at a first angular position;

FIG. 7 is a view similar to FIG. 6, but illustrating the rotatable plug at a second angular position;

FIG. 8 is another view similar to FIG. 6, but illustrating the rotatable plug at a third angular position; and

FIG. 9 is an assembled sectional top view of a second preferred embodiment of the invention.

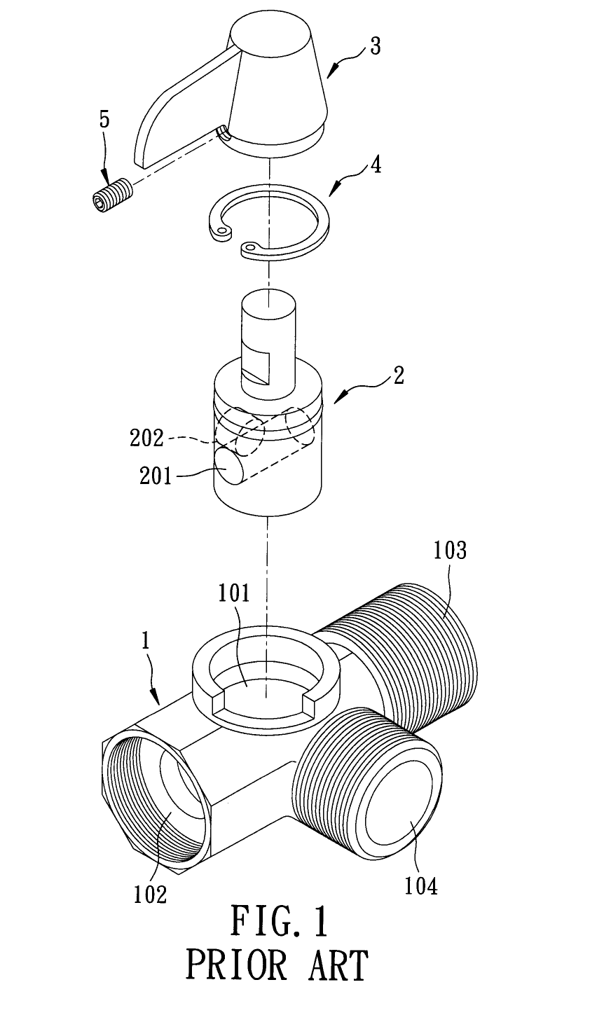

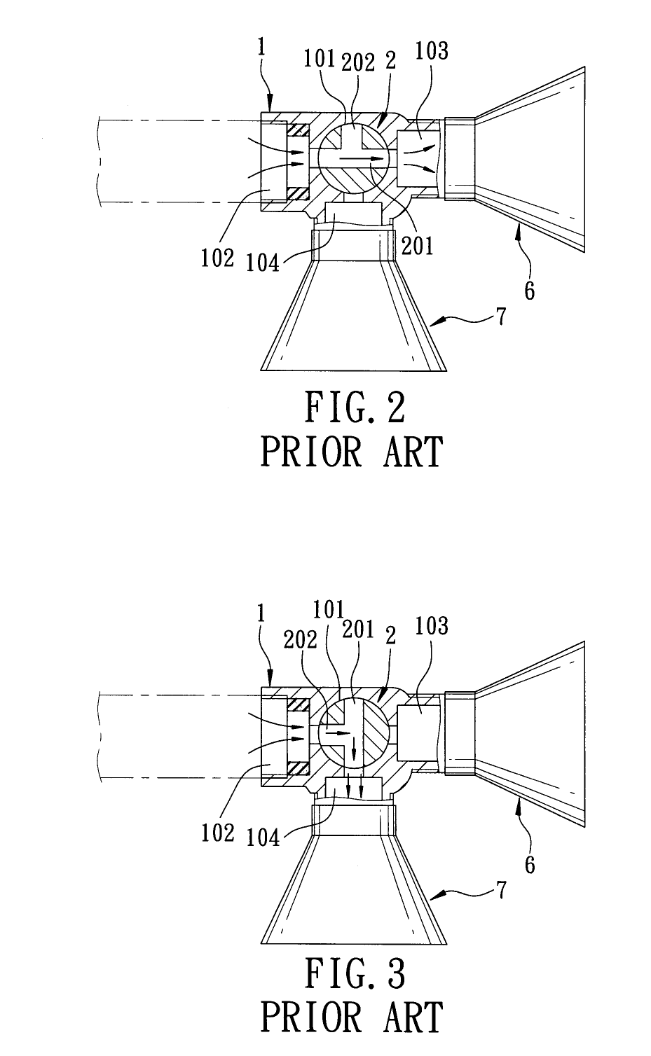

### DETAILED DESCRIPTION OF THE PREFERRED EMBODIMENTS

Before the present invention is described in greater detail, it should be noted that like elements are denoted by the same reference numerals throughout the disclosure.

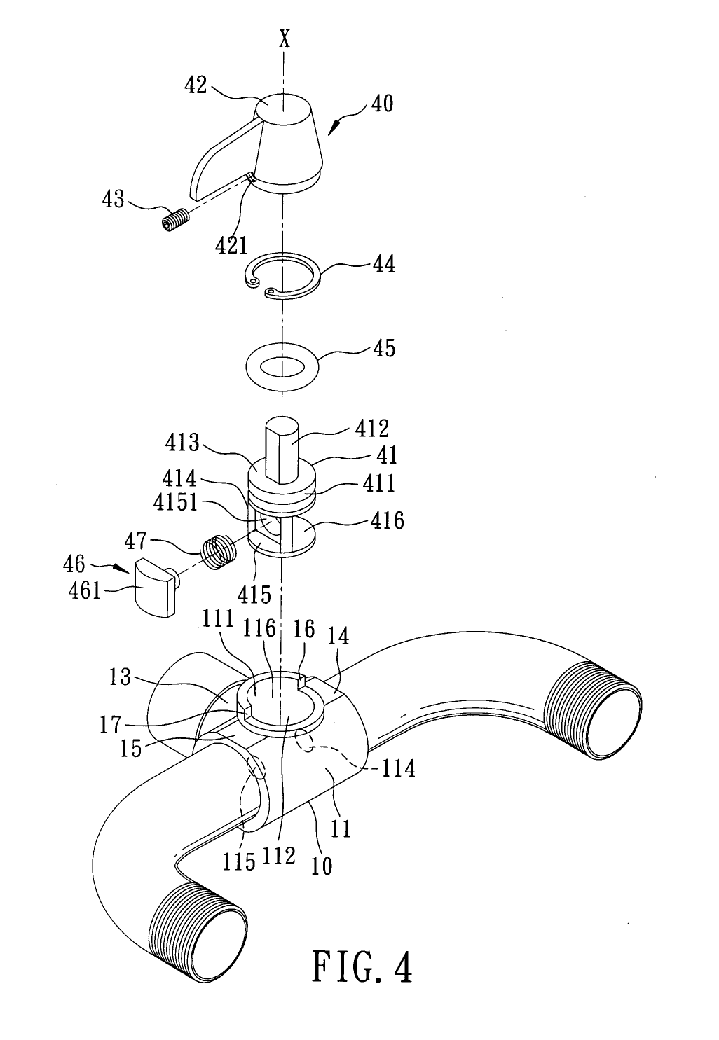

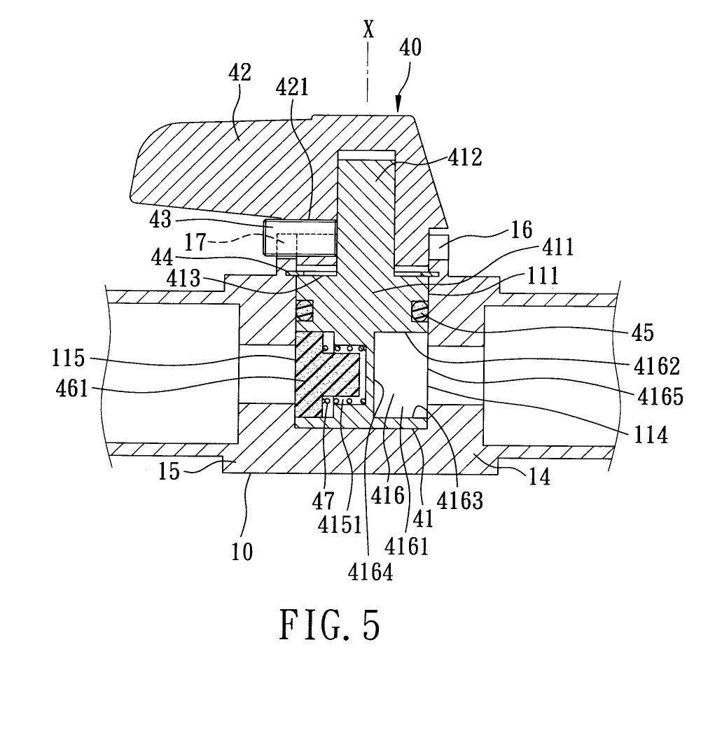

As shown in FIGS. 4 to 6, the first preferred embodiment of a water outlet device according to the present invention comprises a hollow main body 10 and a switch mechanism 40.

The main body 10 has a middle body part 11, a water inlet pipe part 13, and first and second water outlet pipe parts 14, 15. The middle body part 11 is formed with a top opening 116, and has an inner annular surface 111 that surrounds an axis (X), that defines a receiving space 112, and that is formed with a water inlet hole 113 and first and second water outlet holes 114, 115. In this embodiment, the first and second water outlet holes 114, 115 are disposed on opposite sides of the water inlet hole 113. In particular, each of the first and second water outlet holes 114, 115 is angularly spaced apart from the water inlet hole 113 by 90 degrees with respect to the axis (X), i.e., the first and second water outlet holes 114, 115 are spaced apart from each other by 180 degrees with respect to the axis (X). The water inlet pipe part 13 is connected to the middle body part 11 and is fluidly communicated with the receiving space 112 via the water inlet hole 113. The first and second water outlet pipe parts 14, 15 are connected to the middle body part 11 and are fluidly communicated with the receiving space 112 via the first and second water outlet holes 114, 115, respectively. The first water outlet pipe part 14 is adapted to be connected to a first shower head 20 at one end opposite to the middle body part 11. The second water outlet pipe part 15 is adapted to be connected to a second shower head 30 at one end opposite to the middle body part 11. The middle body part 11 is further formed with first and second stops 16, 17 disposed at a periphery of the top opening 116 and spaced apart from each other at 180 degrees with respect to the axis (X).

The switch mechanism 40 includes a rotatable plug 41, a handle 42, a fastener 43, a snap ring 44, a seal ring 45, and a spring-loaded valve unit 46. The rotatable plug 41 has a water control portion 411 disposed in the receiving space 112 in the middle body part 11 of the main body 10 and rotatable about the axis (X). The water control portion 411 has a top surface 413 and an outer surface 414 extending downwardly from the periphery of the top surface 413 and formed with a valve mounting section 415, and a water conduit section 416 that is angularly spaced apart from the valve mounting section 415 with respect to the axis (X). The valve mounting section 415 is formed with a valve mounting recess 4151. The water conduit section 416 is formed with a water channel 4161 that is defined by a top channel wall 4162, a bottom channel wall 4163, and an inner channel wall 4164 that extends between the top and bottom channel walls 4162, 4163. The water channel 4161 has open first and second channel ends 4166, 4167 spaced apart from each other at an angle not less than an angle formed between the first and second water outlet holes 114, 115 with respect to the axis (X). In this embodiment, the first and second channel ends 4166, 4167 are spaced apart from each other by 180 degrees. The water channel 4161 further has a circumferentially extending open side 4165 that extends between the first and second channel ends 4166, 4167, and that is radially spaced apart from the inner channel wall 4164 with respect to the axis (X). The rotatable plug 41 further has a handle coupling portion 412 that extends upwardly from the top surface 413 of water control portion 411 along the axis (X) and outwardly of the receiving space 112 via the top opening 116 in the middle body part 11.

The handle 42 is mounted on the handle coupling portion 412 of the rotatable plug 41. In this embodiment, the handle 42 is formed with a radially extending screw hole 421, and the fastener 43 is a screw that engages threadedly the screw hole 421 and that has a distal screw end 431 abutting against the handle coupling portion 412 for retaining the handle 42 on the handle coupling portion 412.

The snap ring 44 is embedded in the inner annular surface 111 of the middle body part 11 of the main body 10, and abuts against the top surface 413 of the water control portion 411 of the rotatable plug 41 for retaining the water control portion 411 within the receiving space 112 in the middle body part 11. The seal ring 45 is fitted around the outer surface 414 of the water control portion 411, and abuts against the inner annular surface 111 of the middle body part 11 to prevent leakage of water through the top opening 116 in the middle body part 11.

The spring-loaded valve unit 46 is disposed in the valve mounting recess 4151 of the valve mounting section 415 of the water control portion 411 of the rotatable plug 41, and is disposed to abut against the inner annular surface 111 of the middle body part 11 for blocking the first and second water outlet holes 114, 115 selectively. The spring-loaded valve unit 46 includes a valve piece 461 and a spring 47 that has opposite ends abutting against the valve piece 461 and the water control portion 411, respectively. In this embodiment, the valve piece 461 is a rubber pad.

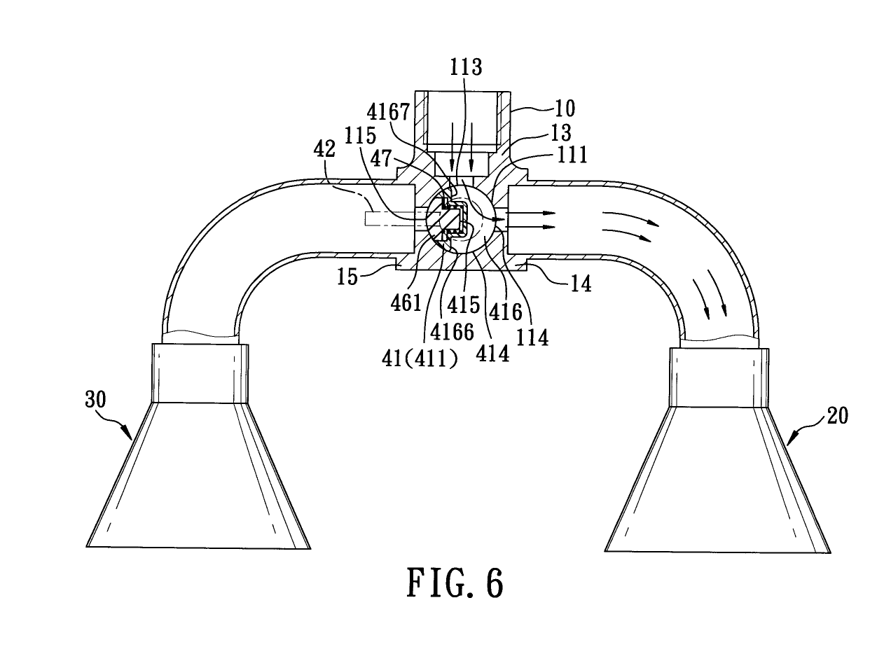

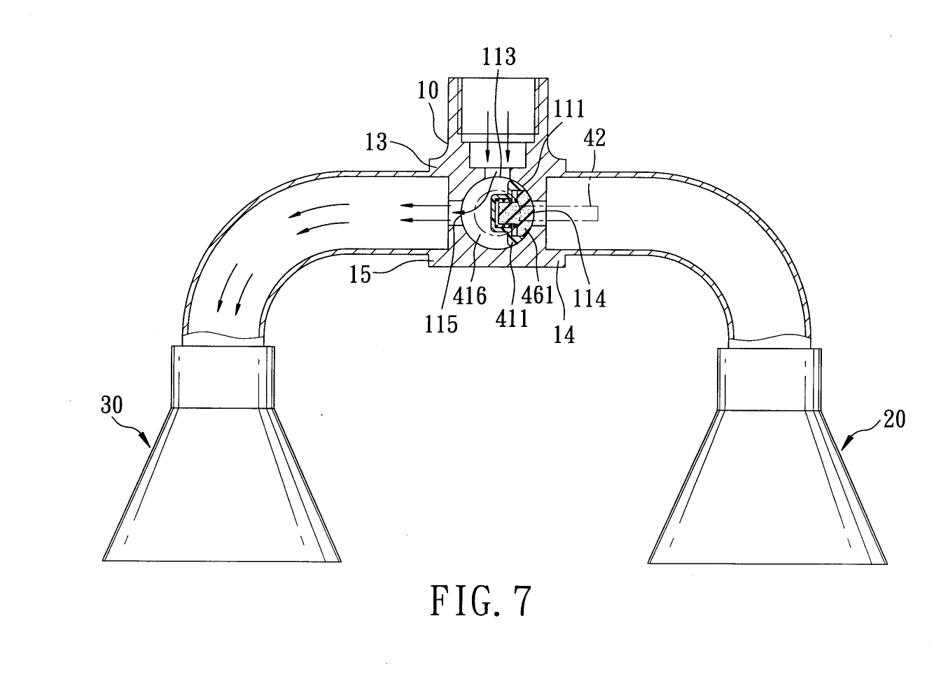

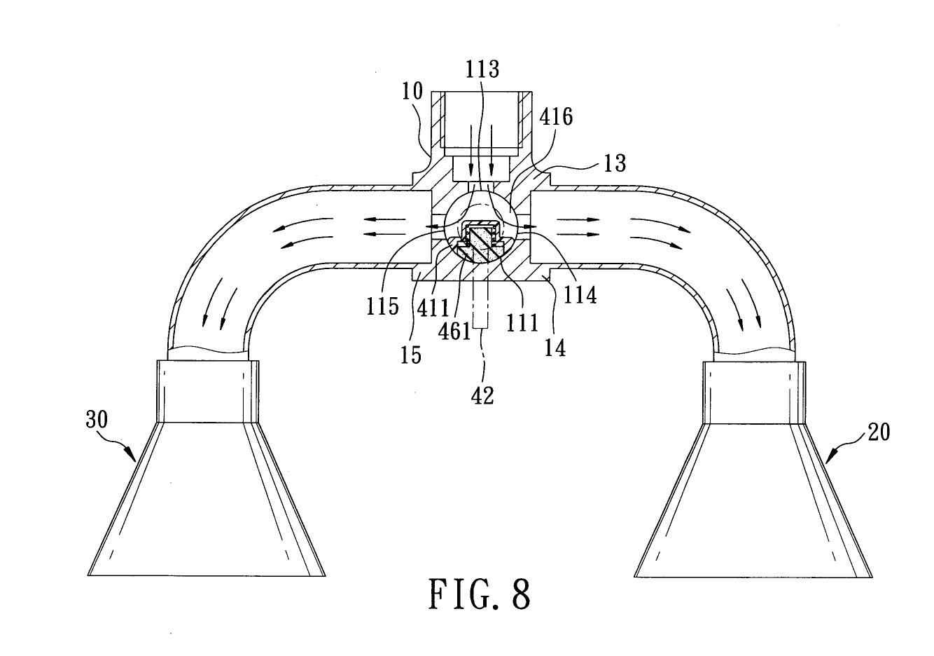

In use, the handle 42 is operable to drive rotation of the rotatable plug 41 of the switch mechanism 40. The water conduit 416 in the water control portion 411 of the rotatable plug 41 is configured to permit fluid communication between the water inlet pipe part 13 of the main body 10 and the first water outlet pipe part 14 of the main body 10 when the water control portion 411 is at a first angular position (see FIG. 6) relative to the axis (X) that enables the valve piece 461 of the spring-loaded valve unit 46 to block the second water outlet hole 115 in the inner annular surface 111 of the middle body part 11, and to permit fluid communication between the water inlet pipe part 13 and the second water outlet pipe part 15 of the main body 10 when the water control portion 411 is at a second angular portion (see FIG. 7) relative to the axis (X) that enables the valve piece 461 to block the first water outlet hole 114 in the inner annular surface 111. The water conduit section 416 further permits fluid communication among the water inlet pipe part 13 and the first and second water outlet pipe parts 14, 15 when the water control portion 411 is at a third angular position (see FIG. 8) relative to the axis (X) that prevents the valve piece 461 from blocking either of the first and second water outlet holes 114, 115. When the water control portion 411 is at the third angular position, the spring-loaded valve unit 46 is disposed opposite to the water inlet hole 113 relative to the axis (X), i.e., the valve piece 461 abuts against the inner annular surface 111 at a position between the first and second water outlet holes 114, 115. During the rotation of the rotatable plug 41, the fastener 43 abuts against one of the first and second stops 16, 17 of the main body 10 when the water control portion 411 is at a corresponding one of the first and second angular positions for positioning the water control portion 411 accurately.

The valve piece 461 of the spring-loaded valve unit 46 abuts resiliently against the inner annular surface 111 of the middle body part 11 of the main body 10 by virtue of the spring 47 so as to block tightly and selectively the first and second water outlet holes 113, 114 in the inner annular surface 111. Since the outer surface 414 of the water control portion 411 is not used to block fluid communication, the water outlet device of this invention can prevent leakage of water more efficiently than the prior art, thereby resulting in a longer service life. Moreover, the water outlet device of this invention can be operated so that water can flow through the first and second water outlet pipe parts 14, 15 of the main body 10 at the same time, thereby resulting in added convenience during use.

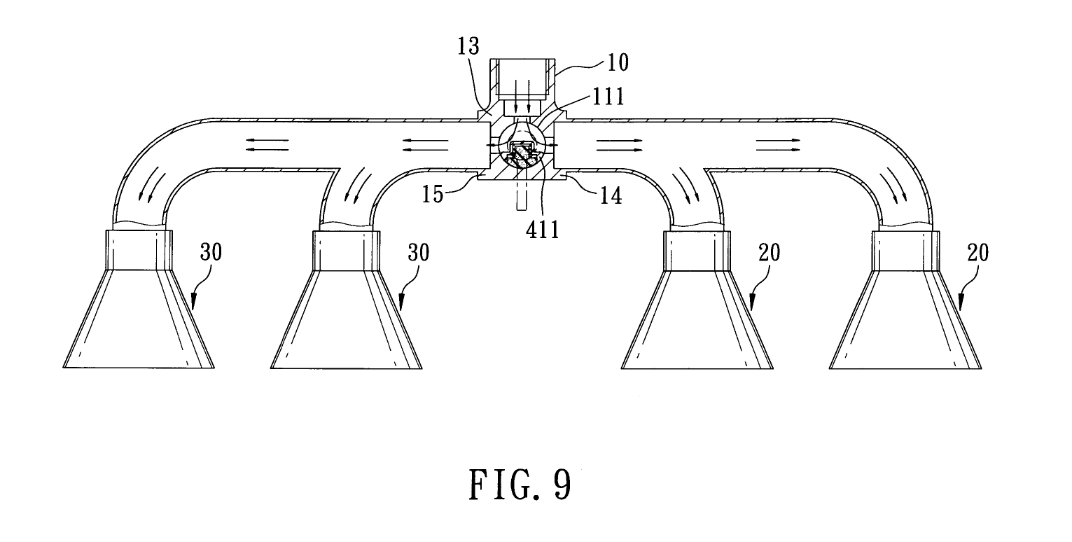

As shown in FIG. 9, the second preferred embodiment of the water outlet device according to the present invention has a structure similar to that of the first embodiment. The main difference between this embodiment and the previous preferred embodiment resides in the following. The first water outlet pipe part 14 of the main body 10 is adapted to be connected to a pair of first shower heads 20, and the second water outlet pipe part 15 of the main body 10 is adapted to be connected to a pair of second shower heads 30. Therefore, the water outlet device of the invention is capable of having two water output flows through the first shower heads 20 respectively and simultaneously when the water control portion 411 of the rotatable plug 41 of the switch mechanism 40 is rotated to the first angular position, another two water output flows through the second shower heads 30 respectively and simultaneously when the water control portion 411 is rotated to the second angular position, and four water output flows through the first and second shower heads 20, 30 respectively and simultaneously when the water control portion 411 is at the third angular position. The second preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A water outlet device comprising:
a hollow main body including
a middle body part having an inner annular surface that surrounds an axis, that defines a receiving space, and that is formed with a water inlet hole and first and second water outlet holes,
a water inlet pipe part connected to said middle body part and fluidly communicated with said receiving space via said water inlet hole, and
first and second water outlet pipe parts connected to said middle body part and fluidly communicated with said receiving space via said first and second water outlet holes, respectively; and
a switch mechanism including
a rotatable plug that has a water control portion disposed in said receiving space and rotatable about the axis, said water control portion having an outer surface with a valve mounting section and a water conduit section angularly spaced apart from said valve mounting section with respect to the axis, and
a spring-loaded valve unit mounted to said valve mounting section of said outer surface of said water control portion and disposed to abut against said inner annular surface for blocking said first and second water outlet holes selectively;
wherein said water conduit section is configured to permit fluid communication between said water inlet pipe part and said first water outlet pipe part when said water control portion is at a first angular position relative to the axis that enables said spring-loaded valve unit to block said second water outlet hole, and to permit fluid communication between said water inlet pipe part and said second water outlet pipe part when said water control portion is at a second angular position relative to the axis that enables said spring-loaded valve unit to block said first water outlet hole.

2. The water outlet device as claimed in claim 1, wherein said water conduit section further permits fluid communication among said water inlet pipe part and said first and second water outlet pipe parts when said water control portion is at a third angular position relative to the axis that prevents said spring-loaded valve unit from blocking either of said first and second water outlet holes.

3. The water outlet device as claimed in claim 2, wherein said first and second water outlet holes are angularly spaced apart from said water inlet hole and are disposed on opposite sides of said water inlet hole, and said spring-loaded valve unit is disposed opposite to said water inlet hole relative to the axis when said water control portion is at the third angular position.

4. The water outlet device as claimed in claim 3, wherein said water conduit section is formed with a water channel that is defined by a top channel wall, a bottom channel wall, and an inner channel wall that extends between said top and bottom channel walls,
said water channel having open first and second channel ends spaced apart from each other at an angle with respect to the axis that is not less than an angle formed between said first and second water outlet holes with respect to the axis,
said water channel further having a circumferentially extending open side that extends between said first and second channel ends and that is radially spaced apart from said inner channel wall with respect to the axis.

5. The water outlet device as claimed in claim 3, wherein:
said middle body part is formed with a top opening,
said water control portion has a top surface,
said rotatable plug further has a handle coupling portion that extends upwardly from said top surface of said water control portion along the axis and outwardly of said receiving space via said top opening in said middle body part, and
said switch mechanism further includes a handle mounted on said handle coupling portion, and a snap ring that is embedded in said inner annular surface and that abuts against said top surface of said water control portion.

6. The water outlet device as claimed in claim 3, wherein:
said middle body part is formed with a top opening,
said rotatable plug further has a handle coupling portion that extends upwardly from said water control portion along the axis and outwardly of said receiving space via said top opening of said middle body part, and
said switch mechanism further includes a handle mounted on said handle coupling portion, and a seal ring fitted around said outer surface of said water control portion and abutting against said inner annular surface to prevent leakage of water through said top opening.

7. The water outlet device as claimed in claim 3, wherein:
said middle body part is formed with a top opening and first and second stops disposed at a periphery of said top opening and spaced apart from each other at an angle corresponding to that formed between said first and second water outlet holes with respect to the axis,
said rotatable plug further has a handle coupling portion that extends upwardly from said water control portion along the axis and outwardly of said receiving space via said top opening of said middle body part, and
said switch mechanism further includes a handle mounted on said handle coupling portion, and a fastener for retaining said handle on said handle coupling portion, said fastener abutting against one of said first and second stops when said water control portion is at a corresponding one of the first and second angular positions.

8. The water outlet device as claimed in claim 7, wherein said handle is formed with a radially extending screw hole, and said fastener is a screw that engages threadedly said screw hole and that has a distal screw end abutting against said handle coupling portion.

9. The water outlet device as claimed in claim 1, wherein:
said valve mounting section is formed with a valve mounting recess, and
said spring-loaded valve unit is disposed in said valve mounting recess, and includes a valve piece and a spring that has opposite ends abutting against said valve piece and said water control portion, respectively.

10. The water outlet device as claimed in claim 9, wherein said valve piece is a rubber pad.
